(19) United States
(12) Patent Application Publication
(10) Pub. No.: US 2026/0095071 A1
(43) Pub. Date: Apr. 2, 2026

(54) OVERMOLDING STATOR AND WATER PUMP INCLUDING THE SAME

(71) Applicant: COAVIS, Sejong-si (KR)

(72) Inventors: Hyuntae LEE, Sejong-si (KR); Wookeun LEE, Sejong-si (KR); Yonghwan CHOI, Daejeon (KR)

(21) Appl. No.: 19/346,088

(22) Filed: Sep. 30, 2025

(30) Foreign Application Priority Data
Sep. 30, 2024 (KR) 10-2024-0133031

(51) Int. Cl. H02K 1/14; H02K 5/22

(52) U.S. Cl. CPC H02K 1/145; H02K 5/225

(57) ABSTRACT

Provided is an overmolding stator including: a stator core having a central portion open in a vertical direction; a primary molding part molded to surround the stator core and having a mold loading part formed to protrude radially outward beyond an outer circumferential surface of the stator core; and a secondary molding part molded to surround the stator core and the primary molding part, wherein the stator core and the primary molding part are embedded inside the secondary molding part, and the mold loading part of the primary molding part is exposed to the outside of the secondary molding part.

### CROSS-REFERENCE TO RELATED APPLICATIONS

This application claims priority under 35 U.S.C. § 119 to Korean Patent Application No. 10-2024-0133031, filed on Sep. 30 2024, in the Korean Intellectual Property Office, the disclosure of which is incorporated herein by reference in its entirety.

### TECHNICAL FIELD

The following disclosure relates to an overmolding stator in which a stator included in a water pump is formed to be embedded inside a motor housing through overmolding, and a water pump having the same.

### BACKGROUND

A water pump is a device for circulating coolant to an engine or a heater for engine cooling, indoor heating, or the like. The water pump is broadly classified into a mechanical water pump and an electric water pump.

The mechanical water pump is a pump driven by rotation of an engine crankshaft through connection to the crankshaft, and the electric water pump is a pump driven by rotation of a motor controlled by a control device.

FIG. 1 is a front cross-sectional view illustrating an electric water pump according to the prior art.

Referring to FIG. 1, the electric water pump according to the prior art may broadly include a housing 10, a stator 20, a can 30, a rotor 40, a rotary shaft 41, a lower bearing 42, an upper bearing 43, an impeller 50, and an upper casing 60.

More specifically, the stator 20 may be disposed inside the housing 10 having a recessed accommodating space, a protrusion formed convexly downward from the can 30 may be inserted into and pass through a central portion of the stator 20, and an upper portion of the can 30 may be coupled to an upper end portion of the housing 10. In addition, an inner side of the protrusion portion of the can 30 may be recessed to provide a space, the rotor 40 may be disposed inside the space, and both ends of the rotary shaft 41 coupled to the rotor 40 may be coupled to and supported by the lower bearing 42 and the upper bearing 43. In addition, the upper casing 60 may be coupled to the upper portion of the can 30, the impeller 50 may thus be disposed in an internal space formed by coupling of the can 30 and the upper casing 60, and the impeller 50 may be coupled to the rotary shaft 41 to rotate together with the rotor 40. Accordingly, fluid introduced through an inlet pipe 61 formed in the upper casing 60 by the rotation of the impeller 50 may be pressurized by passing through the impeller 50 and then discharged through an outlet pipe 62 formed in the upper casing 60. In addition, the stator 20 may be electrically connected to a connector 70.

However, the water pump according to the prior art has a complex structure and a large size due to a large number of parts to be assembled. In order to solve such a disadvantage, the number of parts included in the water pump may be reduced and the size of the water pump may be reduced by integrally forming the stator 20, the can 30, the housing 10, and the connector 70 through molding.

However, when the stator 20, the can 30, the housing 10, and the connector 70 are manufactured to be integrated through overmolding, if an inner circumferential surface of a core of the stator 20 is fixed to the mold and the stator 20 is then molded by resin to manufacture an overmolding stator, the inner circumferential surface of the core of the stator 20 may be exposed to the outside of a molding part. Accordingly, when the water pump is manufactured using such an overmolding stator and used, the inner circumferential surface of the core of the stator 20 and an inner circumferential surface of the molding part may be brought into contact with the fluid to be pumped. Here, the fluid may be introduced into the stator through a boundary where the core of the stator 20 and the molding part meet, which may result in corrosion of the stator or insulation failure of the stator.

### RELATED ART DOCUMENT

### Patent Document

KR 10-2015-0052436 A (2015.05.14) “the water pump”

### SUMMARY

An embodiment of the present disclosure is directed to providing an overmolding stator in which a surface of the stator is not exposed to the outside of a molding part when the overmolding stator is manufactured through overmolding, and a water pump having the same.

In one general aspect, an overmolding stator includes: a stator core having a central portion open in a vertical direction; a primary molding part molded to surround the stator core and having a mold loading part formed to protrude radially outward beyond an outer circumferential surface of the stator core; and a secondary molding part molded to surround the stator core and the primary molding part, wherein the stator core and the primary molding part are embedded inside the secondary molding part, and the mold loading part of the primary molding part is exposed to the outside of the secondary molding part.

A remaining surface of the primary molding part except for the mold loading part and an entire surface of the stator core including an inner circumferential surface of the stator core may be formed not to be exposed to the outside of the secondary molding part.

The mold loading part may protrude radially outward beyond an outer circumferential surface of the secondary molding part.

The mold loading part may be formed at a position corresponding to the stator core in the vertical direction.

A flange may be formed to protrude radially outward from an outer circumferential surface of the secondary molding part, and the flange may protrude radially outward beyond the mold loading part.

The overmolding stator may further include: a coil wound on the stator core and the primary molding part, a terminal, and a terminal carrier to which the terminal is coupled, wherein the terminal carrier is coupled to the primary molding part, the terminal is electrically connected to the coil, and the stator core, the coil, the primary molding part, and the terminal carrier are embedded inside the secondary molding part.

A fixing groove may be recessed inward from a radially outer side surface of the mold loading part.

A pinhole may be formed to be recessed upward from a lower surface of the secondary molding part, and a portion of the terminal carrier corresponding to the pinhole may be exposed to the outside of the secondary molding part.

The mold loading part may be disposed at an upper end of the primary molding part.

In addition, the mold loading part may be further disposed at a lower side of the primary molding part.

An outer surface of the mold loading part may be formed to correspond to an outer surface of the secondary molding part.

The mold loading part may be disposed to be adjacent to an outer periphery of the secondary molding part.

In another general aspect, an overmolding stator includes: a stator core having a central portion open in a vertical direction; a primary molding part molded to surround the stator core and having a mold loading part formed to be recessed radially inward from an outer circumferential surface of the stator core; and a secondary molding part molded to surround the stator core and the primary molding part, wherein the stator core and the primary molding part are embedded inside the secondary molding part, and the mold loading part of the primary molding part is exposed to the outside of the secondary molding part.

A core insertion hole recessed radially inward from an outer circumferential surface of the secondary molding part may be formed at a position corresponding to the mold loading part.

In another general aspect, a water pump includes: the overmolding stator described above; an upper casing coupled to an upper side of the overmolding stator and having an upper channel through which fluid flows; an impeller disposed between the overmolding stator and the upper casing; and a rotor coupled to the impeller and rotatably inserted into a rotor accommodating groove formed in a central portion of the overmolding stator.

Other features and aspects will be apparent from the following detailed description, the drawings, and the claims.

### BRIEF DESCRIPTION OF THE DRAWINGS

FIG. 1 is a front cross-sectional view illustrating an example of an electric water pump according to the prior art.

FIGS. 2 to 4 are a perspective view and a front cross-sectional view illustrating an overmolding stator according to a first embodiment of the present disclosure.

FIGS. 5 and 6 are an exploded perspective view and an assembled perspective view respectively illustrating a stator assembly further including a terminal and a terminal carrier according to the first embodiment of the present disclosure.

FIG. 7 is a cross-sectional view illustrating a state in which the stator assembly according to the first embodiment of the present disclosure is placed in and fixed to a mold.

FIG. 8 is a cross-sectional view illustrating a state in which a secondary molding part is molded on the stator assembly according to the first embodiment of the present disclosure in the mold to complete the overmolding stator.

FIG. 9 is a cross-sectional view illustrating a state in which a stator assembly according to a second embodiment or a third embodiment of the present disclosure is placed in and fixed to the mold.

FIG. 10 is a perspective view illustrating an overmolding stator according to the second embodiment or the third embodiment of the present disclosure.

FIG. 11 is a perspective view illustrating a stator assembly before forming a secondary molding part in an overmolding stator according to a fourth embodiment of the present disclosure.

FIG. 12 is a cross-sectional view illustrating a state in which the stator assembly according to the fourth embodiment of the present disclosure placed in and fixed to the mold.

FIGS. 13 to 15 are an assembled perspective view, an exploded perspective view, and a front cross-sectional view respectively illustrating a water pump including the overmolding stator according to the present disclosure.

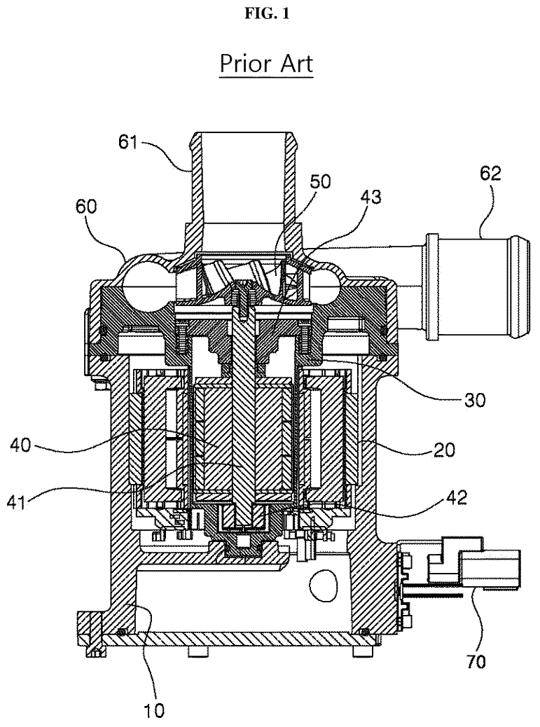

### DETAILED DESCRIPTION OF EMBODIMENTS

Hereinafter, an overmolding stator according to the present disclosure is described in detail with reference to the accompanying drawings.

### First Embodiment

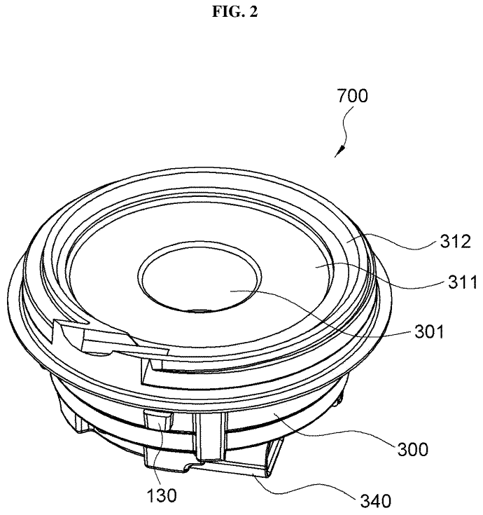

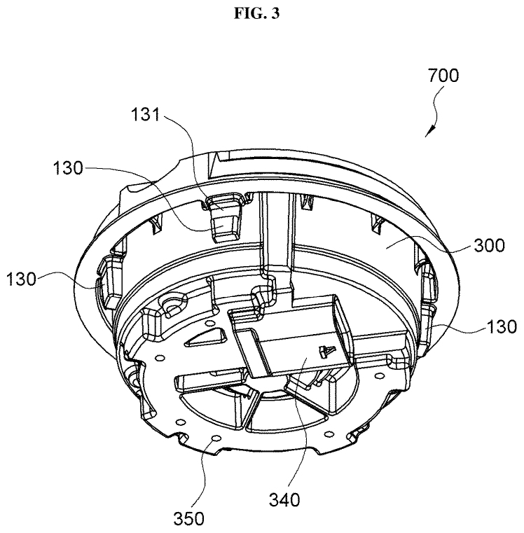

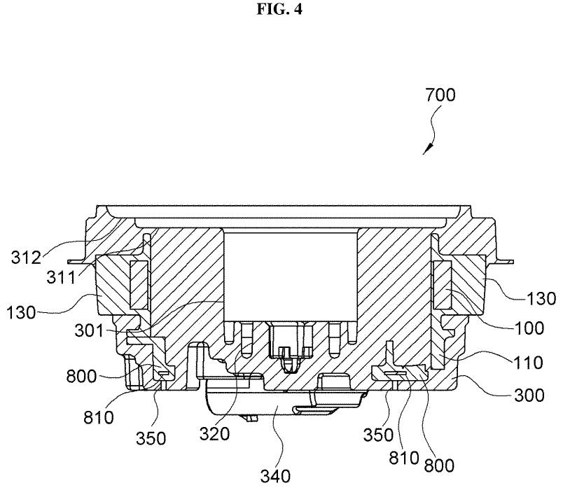

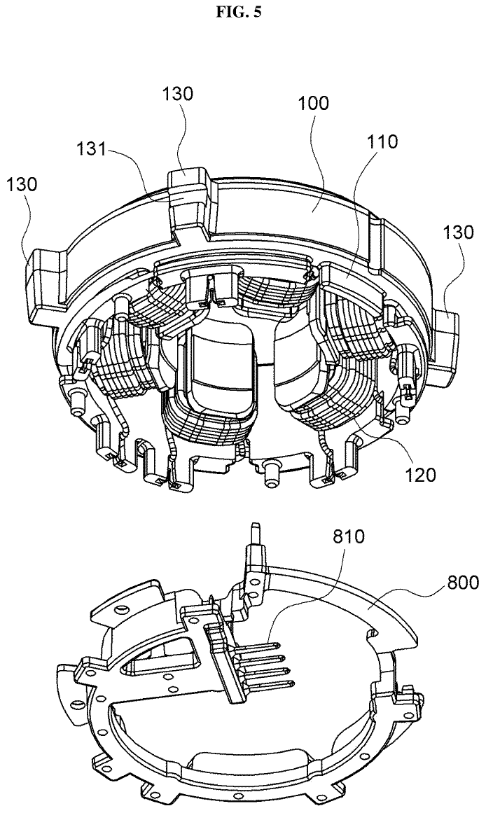

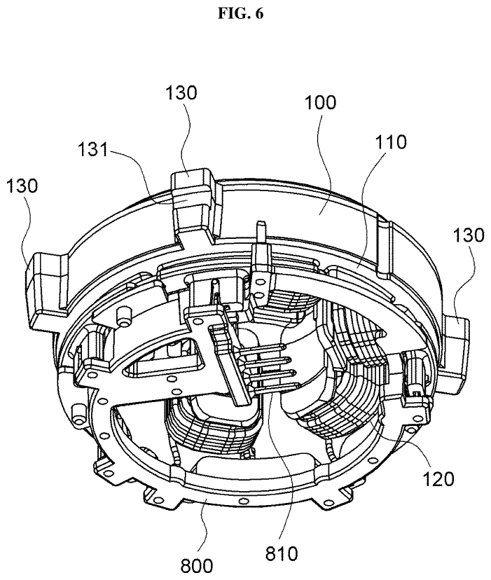

FIGS. 2 to 4 are a perspective view and a front cross-sectional view respectively illustrating an overmolding stator according to a first embodiment of the present disclosure; and FIGS. 5 and 6 are an exploded perspective view and an assembled perspective view respectively illustrating a stator assembly further including a terminal and a terminal carrier according to the first embodiment of the present disclosure.

As illustrated, an overmolding stator 700 according to the first embodiment of the present disclosure may include a stator core 100, a primary molding part 110, and a secondary molding part 300, and may further include a coil 120, a terminal 810, and a terminal carrier 800.

The stator core 100 may be formed in a substantially ring shape to have a central portion open in a vertical direction.

The primary molding part 110 may be made of a resin material, and the primary molding part 110 may be formed in a shape surrounding a portion of the stator core 100 through insert molding. The primary molding part 110 may serve as an insulator, and the coil 120 may be wound on the primary molding part 110 in a state in which the primary molding part 110 is molded on the stator core 100 to be integrally formed with the stator core 100. In addition, a mold loading part 130 may be formed on the primary molding part 110, and the mold loading part 130 may protrude radially outward beyond an outer circumferential surface of the stator core 100. The mold loading part 130 may be formed at a position corresponding to the stator core 100 in the vertical direction.

The terminal 810 may be coupled to the terminal carrier 800. For example, the terminal 810 may be integrally formed with the terminal carrier 800 through insert molding. The terminal carrier 800 may be coupled to the primary molding part 110, and one end of the terminal 810 may be electrically connected to the coil 120.

The secondary molding part 300 may be made of a resin material, and the secondary molding part 300 may be formed in a shape surrounding the stator core 100, the primary molding part 110, the coil 120, the terminal 810, and the terminal carrier 800 through overmolding. For example, the stator core 100, the primary molding part 110, the terminal 810, and the terminal carrier 800 may be embedded inside the secondary molding part 300. In addition, a connector 340 may be integrally formed on the secondary molding part 300, and the other end of the terminal 810 may protrude into an inner space of the connector 340.

Accordingly, the secondary molding part 300 may serve as a motor housing. In addition, a rotor accommodating groove 301 may be recessed downward from an upper surface in a central portion of the secondary molding part 300, a lower seating groove 311 in which the impeller is seated may be recessed in the upper surface of the secondary molding part 300, and a lower channel 312 through which fluid flows may be formed at a position radially spaced outward from the lower seating groove 311.

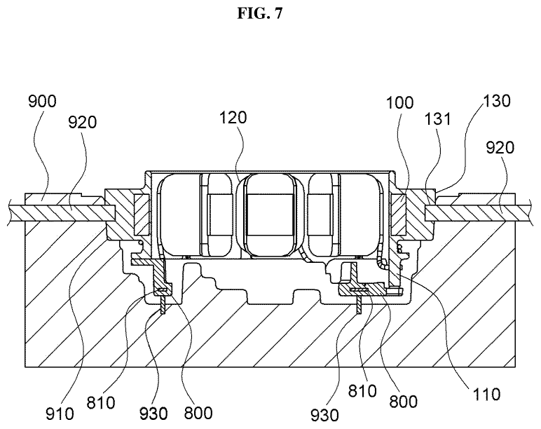

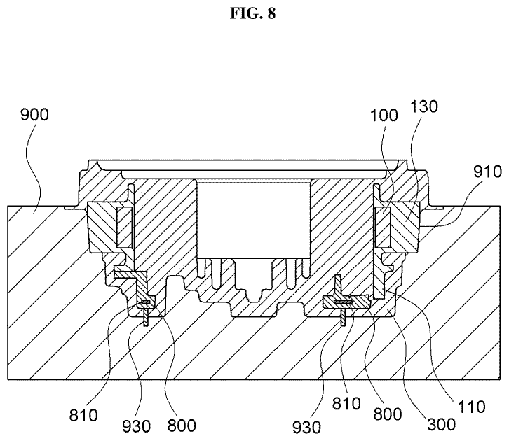

FIG. 7 is a cross-sectional view illustrating a state in which the stator assembly according to the first embodiment of the present disclosure is placed in and fixed to the mold; and FIG. 8 is a cross-sectional view illustrating a state in which the secondary molding part is molded on the stator assembly according to the first embodiment of the present disclosure in the mold to complete the overmolding stator.

Here, the mold loading part 130 of the primary molding part 110 may be exposed to the outside of the secondary molding part 300. When the stator assembly formed by coupling the stator core 100, the primary molding part 110, the coil 120, the terminal 810, and the terminal carrier 800 to one another is fixed to the mold during overmolding, the mold loading part 130 may be brought into contact with and fixed to the mold, and the secondary molding part 300 may be formed through molding in such a state. Accordingly, after overmolding, only the mold loading part 130 of the primary molding part 110 may be exposed to the outside of the secondary molding part 300, and a remaining portion of the primary molding part 110, the stator core 100, the coil 120, a portion of the terminal 810, and the terminal carrier 800 may be embedded inside the secondary molding part 300. That is, a remaining surface of the primary molding part 110 except for the mold loading part 130 and an entire surface of the stator core 100 including an inner circumferential surface of the stator core 100 may be formed not to be exposed to the outside of the secondary molding part.

Accordingly, the overmolding stator according to the present disclosure may be easily formed by using the mold loading part of the primary molding part to prevent the surface of the stator core from being exposed to the outside of the secondary molding part. The surface of the stator core may be prevented from being exposed to the outside of the secondary molding part to prevent fluid from being leaked into the stator core, thereby preventing corrosion of the stator and maintaining insulation of the stator.

In addition, the mold loading part 130 may be exposed to the outside of the secondary molding part 300, and the mold loading part 130 may be formed to protrude radially outward beyond an outer circumferential surface of the secondary molding part 300. The reason is that, during overmolding, the mold loading part 130 may be inserted into and fixed to an insertion groove 910 recessed in the mold 900, thereby fixing the stator assembly formed by coupling the stator core 100, the primary molding part 110, the coil 120, the terminal 810, and the terminal carrier 800 to one another more firmly to the mold. Accordingly, the overmolding stator 700 formed through overmolding may be formed in a shape in which the mold loading part 130 protrudes from the outer circumferential surface of the secondary molding part 300. Here, as the mold loading part 130 is inserted into and coupled to the insertion groove 910 of the mold 900, the stator assembly may be fixed relative to the mold against rotation and in a radial direction. In addition, the stator assembly may be disposed in a state in which a lower end of the stator assembly floats from an inner bottom surface of the mold, thereby facilitating molding. In addition, the lower end of the mold loading part 130 may be supported, thereby restricting downward movement of the stator assembly.

In addition, the mold loading part 130 may be formed at a height corresponding to the stator core 100 in the vertical direction. That is, the mold loading part 130 may be disposed at a height between the upper and lower ends of the stator core 100. Accordingly, when the mold loading part 130 is fixed to the mold, an interval between an outer surface of the stator assembly and an inner surface of the mold may be maintained more uniformly relative to the mold loading part 130.

In addition, a flange may be formed to protrude from the secondary molding part 300. The flange may be formed to protrude radially outward from the outer circumferential surface of the secondary molding part 300, and the flange may protrude radially outward beyond the mold loading part 130. Accordingly, an object to be welded may be coupled to the overmolding stator 700, and a flange part of the secondary molding part 300 and the object to be welded may then be easily coupled to each other by a welding method such as laser welding.

In addition, a lower bearing mounting part 320 may be formed at a bottom of the rotor accommodating groove 301 of the secondary molding part 300, and a lower bearing 330 may be coupled to the lower bearing mounting part 320.

In addition, a fixing groove 131 may be formed in the mold loading part 130. The fixing groove 131 may be formed to be recessed inward from a radially outer side surface of the mold loading part 130. Accordingly, after the mold loading part 130 is fixed to the mold, a slide core 920 of the mold may be moved radially inward from a lateral side of the mold and inserted into the fixing groove 131, thereby fixing the mold loading part 130 to the mold. Accordingly, the stator assembly may be fixed more firmly to the mold, thereby restricting the movement of the stator assembly to ensure the stator assembly does not move upward, thereby restricting the movement of the stator assembly in all directions. Accordingly, the stator assembly may be prevented from moving when the secondary molding part 300 is formed, thereby accurately forming a shape of the secondary molding part.

In addition, a pinhole 350 may be formed to be recessed upward from a lower surface of the secondary molding part 300. The terminal carrier 800 may be exposed to the outside of the secondary molding part through the pinhole 350. That is, a portion of the terminal carrier 800 corresponding to the pinhole 350 may be exposed to the outside of the secondary molding part 300. Here, a terminal carrier fixing pin 930 may be coupled to a bottom surface of the mold 900, and a lower surface of the terminal carrier 800 may be in contact with and supported by an upper end of the terminal carrier fixing pin 930. Accordingly, when the secondary molding part 300 is formed, an interval between the stator assembly and the terminal carrier 800 may be uniformly maintained. In addition, when the secondary molding part 300 is formed and the overmolding stator is then taken out from the mold, the pinhole 350 may be formed at a position where the terminal carrier fixing pin 930 was disposed, and the terminal carrier 800 may be exposed through the pinhole 350.

### Second Embodiment

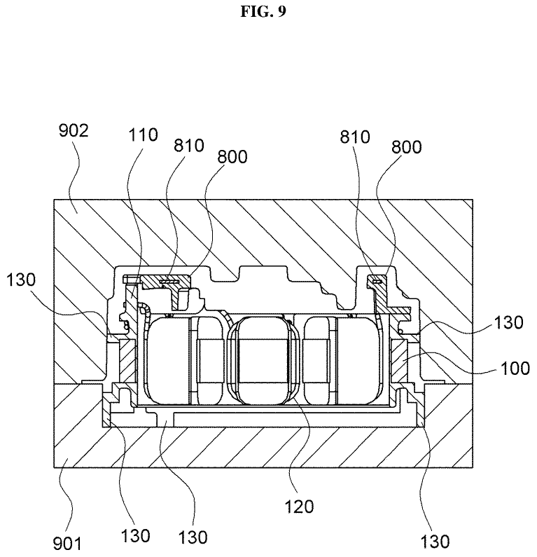

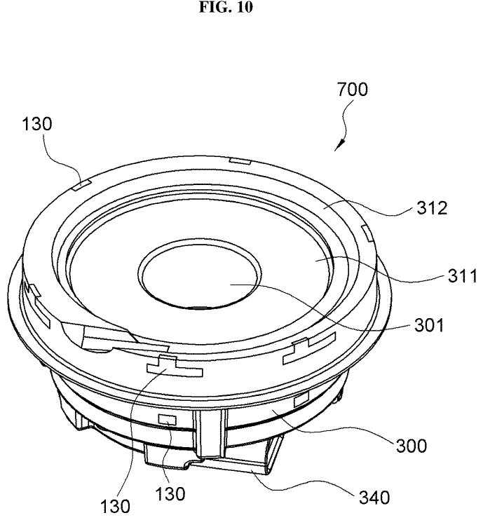

FIG. 9 is a cross-sectional view illustrating a state in which a stator assembly according to the second embodiment or a third embodiment of the present disclosure is placed in and fixed to the mold; and FIG. 10 is a perspective view illustrating an overmolding stator according to the second embodiment or the third embodiment of the present disclosure.

As illustrated, the mold loading part 130 may be disposed at an upper end of the primary molding part 110. Here, the stator assembly including the stator core 100 and the primary molding part 110 may be turned over to enable the primary molding part 110 to be supported by and fixed to the inner circumferential surface and bottom surface of a lower mold 901, and the secondary molding part 300 may then be formed through overmolding, thereby manufacturing the overmolding stator 700. Accordingly, the overmolding stator may be easily formed to facilitate fixing of the stator assembly to the mold during overmolding and to prevent the surface of the stator core 100 from being exposed to the outside of the secondary molding part 300 when overmolding is performed. In addition, in the overmolding stator 700 manufactured through overmolding, the mold loading part 130 may be disposed to be adjacent to an outer periphery of the secondary molding part 300, and the mold loading part 130 may be exposed on the upper outer circumferential surface and upper surface of the secondary molding part 300. In addition, an outer side surface of the mold loading part 130 exposed to the outside of the secondary molding part 300 may be formed to correspond to an outer surface of the secondary molding part 300. That is, the outer surface of the secondary molding part 300 and the outer surface of the mold loading part 130 may be disposed on the same curved surface or plane. In addition, the mold loading part 130 may be disposed radially spaced outward from the lower channel 312. In addition, although not illustrated, even in the second embodiment, the secondary molding part may be formed through overmolding in a state in which a coil, a terminal, and a terminal carrier are coupled to the stator assembly including the stator core 100 and the primary molding part 110.

### Third Embodiment

As illustrated, the mold loading part 130 may be disposed at the upper end of the primary molding part 110, and the mold loading part 130 may be further disposed at a lower side of the primary molding part 110. That is, the mold loading part 130 may be disposed to be spaced apart from the upper end and lower side of the primary molding part 110 in the vertical direction. Here, the stator assembly including the stator core 100 and the primary molding part 110 may be turned over to enable a lower end of the primary molding part 110 to be supported by and fixed to the inner circumferential surface and bottom surface of the lower mold 901, an upper mold 902 may then be covered to enable the upper mold loading part 130 to be brought into contact with and fixed to an inner circumferential surface of the upper mold 902, and the secondary molding part 300 may then be formed through overmolding, thereby manufacturing the overmolding stator 700. In addition, the outer surface of the mold loading part 130 may be formed to correspond to the outer surface of the secondary molding part 300. Accordingly, the overmolding stator may be easily formed to facilitate fixing of the stator assembly to the mold during overmolding and to prevent the surface of the stator core 100 from being exposed to the outside of the secondary molding part 300 when overmolding is performed. In addition, an interval between the mold and the stator assembly may be maintained uniformly, thereby accurately forming a shape of the overmolding stator 700. In addition, although not illustrated, even in the third embodiment, the secondary molding part may be formed through overmolding in a state in which a coil, a terminal, and a terminal carrier are coupled to the stator assembly including the stator core 100 and the primary molding part 110.

### Fourth Embodiment

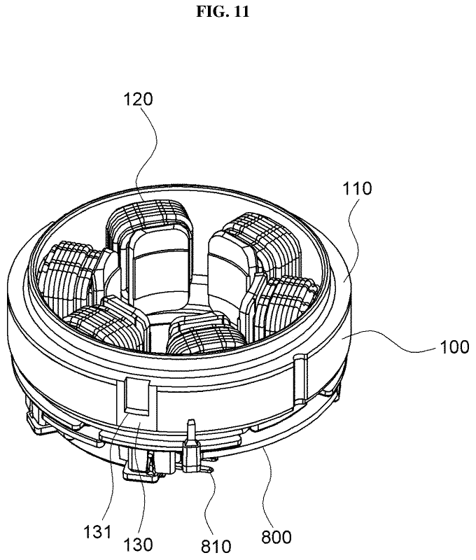

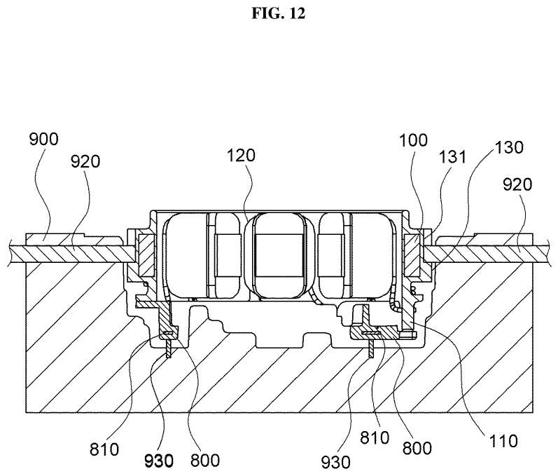

FIG. 11 is a perspective view illustrating a stator assembly before forming a secondary molding part in an overmolding stator according to the fourth embodiment of the present disclosure, and FIG. 12 is a cross-sectional view illustrating a state in which the stator assembly according to the fourth embodiment of the present disclosure placed in and fixed to the mold.

As illustrated, the mold loading part 130 may be formed in a shape recessed radially inward from the outer circumferential surface of the stator core. That is, an outer circumferential surface of the primary molding part 110 may be formed to coincide with the outer circumferential surface of the stator core 100, and a portion including the recessed fixing groove 131 formed in the outer circumferential surface of the primary molding part 110 may be the mold loading part 130. Accordingly, after the stator assembly is inserted into the mold 900, the slide core 920 may be moved radially inward from the lateral side of the mold, and the slide core 920 may be inserted into the fixing groove 131 of the mold loading part 130, thereby firmly fixing the stator assembly to the mold. In addition, when the secondary molding part 300 is formed and the overmolding stator is then taken out from the mold, a core insertion hole recessed radially inward from an outer circumferential surface of the secondary molding part 300 may be formed at a position corresponding to the mold loading part 130. In addition, through the core insertion hole, the fixing groove 131 of the mold loading part 130 may be exposed to the outside of the secondary molding part 300. Accordingly, the overmolding stator may not include any portion where the primary molding part 110 protrudes radially outward from the outer circumferential surface of the secondary molding part 300.

In addition, even in the fourth embodiment, the secondary molding part may be formed through overmolding in a state in which a coil, a terminal, and a terminal carrier are coupled to the stator assembly including the stator core 100 and the primary molding part 110.

In addition, in the second to the fourth embodiments of the present disclosure, components other than portions different from the first embodiment may be applied in the same manner as in the first embodiment described above.

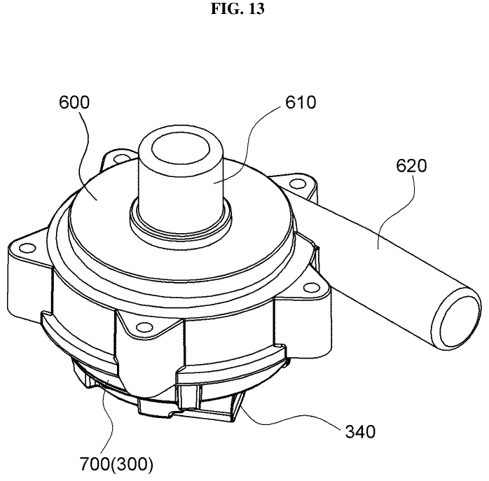

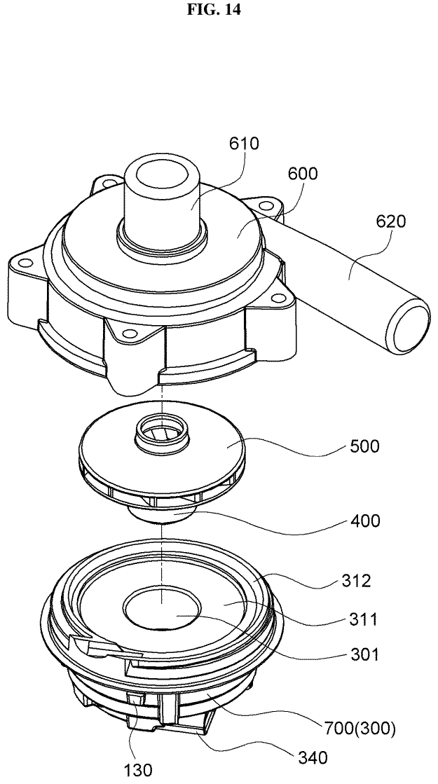

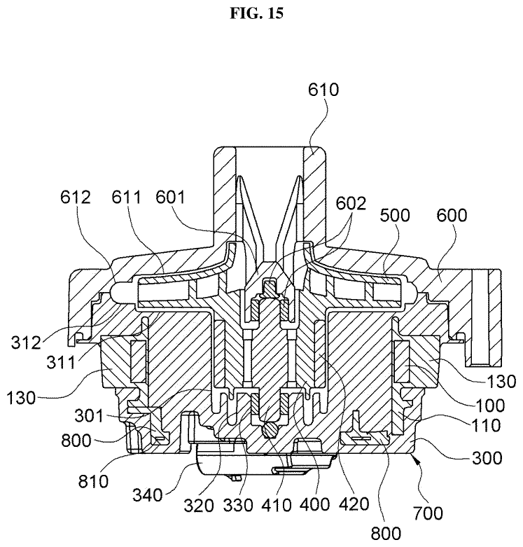

FIGS. 13 to 15 are an assembled perspective view, an exploded perspective view, and a front cross-sectional view respectively illustrating a water pump including the overmolding stator according to the present disclosure.

As illustrated, the water pump according to the present disclosure may include the overmolding stator 700 according to any one of the first embodiment, the second embodiment, the third embodiment, and the fourth embodiment, an upper casing 600, an impeller 500, and a rotor 400.

The upper casing 600 may be coupled to an upper side of the overmolding stator 700. An upper seating groove 611 recessed upward may be formed on a lower surface of the upper casing 600 to accommodate a portion of the impeller 500. An upper channel 612 through which fluid discharged from the impeller 500 flows may be formed radially outward from the upper seating groove 611. The upper channel 612 may be disposed at a position corresponding to the lower channel 312. In addition, an inlet part 610 through which fluid is introduced and an outlet part 620 through which fluid is discharged may be formed in the upper casing 600. In addition, an upper bearing mounting part 601 may be integrally formed in the upper casing 600, and an upper bearing 602 may be coupled to the upper bearing mounting part 601. In addition, an outer side wall of the upper casing 600 may be fitted to an upper end of the overmolding stator 700, and the outer side wall of the upper casing 600 may be joined to the overmolding stator 700 by laser welding or the like in a state of being in contact with an upper surface of the flange of the overmolding stator 700.

The impeller 500 may be disposed in an inner space formed by coupling of the upper casing 600 and the overmolding stator 700. An upper side of the impeller 500 may be inserted into the upper seating groove 611, and a lower side of the impeller 500 may be inserted into the lower seating groove 311. The impeller 500 may serve to pump fluid introduced through the inlet part 610 of the upper casing 600 toward the outlet part 620 by rotation. For example, the impeller 500 may be a centrifugal impeller in which fluid is introduced to an upper central portion, passes inside, and then is discharged radially outward.

The rotor 400 may be coupled to the impeller 500, and the rotor 400 and the impeller 500 may thus rotate together. The rotor 400 may be inserted into the rotor accommodating groove 301 formed in the central portion of the secondary molding part 300, and an outer circumferential surface of the rotor 400 may be disposed to be spaced apart from the rotor accommodating groove 301. For example, the rotor 400 may be integrally formed with the impeller 500. The rotor 400 may be formed to protrude downward from a central portion of a lower surface of the impeller 500, and the rotor 400 may be radially inserted into and disposed in a hollow inside of the stator core 100. In addition, a magnet 420 may be disposed to be adjacent to the outer circumferential surface of the rotor 400, the magnet 420 may be disposed to be radially spaced apart from the inside of the stator core 100, and the stator core 100 and the magnet 420 may thus be disposed at positions corresponding to each other. In addition, the lower bearing mounting part 320 may be formed at a bottom of the rotor accommodating groove 301 of the secondary molding part 300, and the lower bearing 330 may be coupled to the lower bearing mounting part 320. In addition, a rotation shaft 410 may be integrally formed with the rotor 400, an upper end of the rotation shaft 410 may be coupled to the upper bearing 602, and a lower end of the rotation shaft 410 may be coupled to the lower bearing 330.

As set forth above, the overmolding stator according to the present disclosure and the water pump having the same are formed to prevent the surface of the stator from being exposed to the outside of the molding part, thereby preventing the fluid from being introduced toward the stator, preventing the corrosion of the stator and maintaining the insulation of the stator.

The present disclosure is not limited to the above-described embodiments, may be variously applied, and may be variously modified by those skilled in the art to which the present disclosure pertains without departing from the gist of the present disclosure claimed in the appended claims.

What is claimed is:

1. An overmolding stator comprising:
a stator core having a central portion open in a vertical direction;
a primary molding part molded to surround the stator core and having a mold loading part formed to protrude radially outward beyond an outer circumferential surface of the stator core; and
a secondary molding part molded to surround the stator core and the primary molding part,
wherein the stator core and the primary molding part are embedded inside the secondary molding part, and the mold loading part of the primary molding part is exposed to the outside of the secondary molding part.

2. The overmolding stator of claim 1, wherein a remaining surface of the primary molding part except for the mold loading part and an entire surface of the stator core including an inner circumferential surface of the stator core are formed not to be exposed to the outside of the secondary molding part.

3. The overmolding stator of claim 1, wherein the mold loading part protrudes radially outward beyond an outer circumferential surface of the secondary molding part.

4. The overmolding stator of claim 1, wherein the mold loading part is formed at a position corresponding to the stator core in the vertical direction.

5. The overmolding stator of claim 1, wherein a flange is formed to protrude radially outward from an outer circumferential surface of the secondary molding part, and the flange protrudes radially outward beyond the mold loading part.

6. The overmolding stator of claim 1, further comprising:
a coil wound on the stator core and the primary molding part, a terminal, and a terminal carrier to which the terminal is coupled,
wherein the terminal carrier is coupled to the primary molding part, the terminal is electrically connected to the coil, and
the stator core, the coil, the primary molding part, and the terminal carrier are embedded inside the secondary molding part.

7. The overmolding stator of claim 1, wherein a fixing groove is recessed inward from a radially outer side surface of the mold loading part.

8. The overmolding stator of claim 6, wherein a pinhole is formed to be recessed upward from a lower surface of the secondary molding part, and
a portion of the terminal carrier corresponding to the pinhole is exposed to the outside of the secondary molding part.

9. The overmolding stator of claim 1, wherein the mold loading part is disposed at an upper end of the primary molding part.

10. The overmolding stator of claim 9, wherein the mold loading part is further disposed at a lower side of the primary molding part.

11. The overmolding stator of claim 1, wherein an outer surface of the mold loading part is formed to correspond to an outer surface of the secondary molding part.

12. The overmolding stator of claim 1, wherein the mold loading part is disposed to be adjacent to an outer periphery of the secondary molding part.

13. An overmolding stator comprising:
a stator core having a central portion open in a vertical direction;
a primary molding part molded to surround the stator core and having a mold loading part formed to be recessed radially inward from an outer circumferential surface of the stator core; and
a secondary molding part molded to surround the stator core and the primary molding part,
wherein the stator core and the primary molding part are embedded inside the secondary molding part, and the mold loading part of the primary molding part is exposed to the outside of the secondary molding part.

14. The overmolding stator of claim 1, wherein a core insertion hole recessed radially inward from an outer circumferential surface of the secondary molding part is formed at a position corresponding to the mold loading part.

15. A water pump comprising:
the overmolding stator of claim 1;
an upper casing coupled to an upper side of the overmolding stator and having an upper channel through which fluid flows;
an impeller disposed between the overmolding stator and the upper casing; and
a rotor coupled to the impeller and rotatably inserted into a rotor accommodating groove formed in a central portion of the overmolding stator.

16. A water pump comprising:
the overmolding stator of claim 13;
an upper casing coupled to an upper side of the overmolding stator and having an upper channel through which fluid flows;
an impeller disposed between the overmolding stator and the upper casing; and
a rotor coupled to the impeller and rotatably inserted into a rotor accommodating groove formed in a central portion of the overmolding stator.
